(19) United States
(12) Patent Application Publication
(10) Pub. No.: US 2010/0322495 A1
(43) Pub. Date: Dec. 23, 2010

(54) MEDICAL IMAGING SYSTEM

(75) Inventors: Antoine Collet-Billon, Eindhoven (NL); Benoit Mory, Eindhoven (NL)

Correspondence Address: PHILIPS INTELLECTUAL PROPERTY & STANDARDS, P.O. BOX 3001, Briarcliff Manor, NY, 10510-8001, US

(73) Assignee: Koninklijke Philips Electronics N.V., Eindhoven (NL)

(21) Appl. No.: 12/517,873

(22) PCT Filed: Dec. 10, 2007
(86) PCT No.: PCT/IB07/54982

§ 371 Date: Jun. 5, 2009

(30) Foreign Application Priority Data
Dec. 12, 2006 (EP) 06301238.9

(51) Int. Cl. G06K 9/00

(52) U.S. Cl. 382/131

(57) ABSTRACT

The invention relates to a medical imaging system. First, a sequence of images of a part of a body (BO) is acquired. Second, a feature of interest is detected automatically. Third, at least one parameter characteristic of said feature of interest for each image acquired is computed. Finally, the parameter having the 5 greatest value among the computed parameters is displayed automatically.

### FIELD OF THE INVENTION

The present invention relates to a medical imaging system, and to a corresponding method. The invention finds, in particular, its application in the domain of obstetric Ultrasound imaging.

### BACKGROUND OF THE INVENTION

A known medical imaging system makes it possible to acquire a sequence of 2D images of a part of a body and to display it on a screen, to detect visually on the screen a feature of interest, to manually freeze the acquisition on a specific image, to manually detect the feature of interest, and then to manually perform a measurement of said feature of interest (generally using a trackball). Then the associated parameters coming from the measurement are displayed at the end of the acquisition of the sequence. As an example, it is required to know the length of the femur of a fetus to control the development of the fetus. In order to precisely follow the evolution of the length of the femur, this requires freezing acquisition of the sequence of images when the acquisition plane is exactly parallel to the femur.

One drawback of said imaging system is that the user of said system is losing time when he wants to make these measurements. If the measured parameters are not satisfying for the user, he has to start again all the sequence of actions mentioned above. Moreover, the measured parameter way not be the required parameter if the user has not frozen the acquisition on the required image. In the example above, this would be the case if the user has frozen acquisition when the acquisition plane is not parallel to the femur.

### SUMMARY OF THE INVENTION

It is an object of embodiments of the invention to propose a system, which permits a user to save time and help him for the measurement of a feature of interest.

To this end, the system comprises, in an embodiment, means for controlling the following operations:
automatic detection of a feature of interest in a sequence of images of a part of a body,
computation of at least one parameter characteristic of said feature of interest for each image of the sequence of images, and
automatic display of the parameter having the greatest value among the computed parameters.

The automatic display of the parameter corresponding to the greatest value among the computed parameters characteristic of the feature of interest permits the user to save time. Moreover, it improves the precision of the measurement. In the example of the femur of a fetus, this parameter will necessarily correspond to the length of the femur in an acquisition plane parallel to the femur, as this is the greatest possible length.

According to a not limited embodiment, the controlling means are also arranged to control the following operation: automatic display of the computed parameter associated to an image during a display of said associated image. The display in real-time permits the user to adapt the acquisition (for instance the orientation of an ultrasound probe) as a function of the displayed parameters.

According to a not limited embodiment, the controlling means are also arranged to control the following operation: automatic display of calipers, said calipers being set on boundaries of the feature of interest. This helps the user to locate the feature of interest in the sequence of images.

The present invention also relates to a method for medical imaging which comprises the steps of:
automatically detecting a feature of interest in a sequence of images of a part of a body,
computing at least one parameter characteristic of said feature of interest for each image of the sequence of images, and
automatically displaying the parameter having the greatest value among the computed parameters.

The present invention finally relates to a computer program product comprising program instructions for implementing said method when said program is executed by a processor.

These and other aspects of the invention will be apparent from and will be elucidated with reference to the embodiments described hereinafter.

### BRIEF DESCRIPTION OF THE DRAWINGS

The present invention will now be described in more detail, by way of not limited examples, with reference to the accompanying drawings, wherein:

FIG. 1 is a schematic diagram of a system according to an embodiment of the invention which cooperates with a probe;

FIG. 2 is a schematic drawing of a first feature of interest, from which a sequence of images is acquired via a system according to an embodiment of the invention;

FIG. 3 is a schematic drawing of a second feature of interest, from which a sequence of images is acquired via a system according to an embodiment of the invention;

FIG. 4 represents a diagram of a method for medical imaging according to an embodiment of the invention.

### DETAILED DESCRIPTION OF THE INVENTION

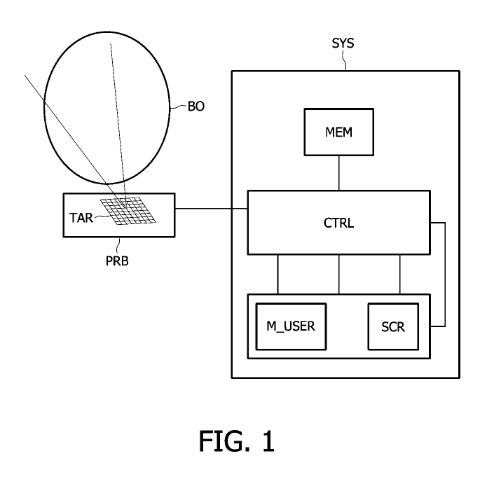

A system SYS in accordance with an embodiment of the invention is described in FIG. 1.

It cooperates with a transducer's array TAR and its associated electronics, the whole forming a probe PRB.

The system SYS comprises a controller CTRL for controlling the following operations:
acquisition of a sequence of images SQ of a part of a body BO;
automatic detection of a feature of interest FI on said sequence of images SQ;
computation of at least one parameter PA characteristic of said feature of interest FI for each image I of the sequence of images SQ; and
automatic display of the parameter PAO having the greatest value among the computed parameters PA.

The system SYS further optionally comprises, a screen SCR for displaying the sequences of images acquired, such as a LCD screen, and a user interface M_USER.

The system SYS comprises a memory MEM in order to save the images I acquired.
In an embodiment, the controller CTRL is further arranged to:
control display of the sequence of images SQ;
control automatic display, of the computed parameter PA associated to an image I during the display of said associated image I.

The controller CTRL may further be arranged to control automatic display of calipers C, said calipers C being set on boundaries of the feature of interest FI.

It is to be noted that the controller CTRL comprises a microprocessor that can be pre-programmed by means of instructions or that can be programmed by a user of the system SYS, for instance via the interface M_USER.

It is to be noted that an image I is a grey level image that may also be a slice in a 3D dataset which is usually called a MPR “Multiplanar Reconstruction” view.

Such a system SYS may be used in obstetrical Ultrasound in particular, where there are foetal standard growth measurements (namely femur length, skull head circumference, abdomen circumference) to be performed that aim at estimating the weight of the fetus.

The operations controlled by the system SYS are described hereinafter in detail.

1) Acquisition of a Sequence of images SQ

In order to acquire a sequence of images SQ of a part of a body, the probe PRB is applied on the body of a patient. The user of the system SYS moves the probe PRB on the part of the body BO which is of interest. For example, the user is interested in acquiring images of the skull or the abdomen of a fetus, or of a femur.

A sequence of grey level images in two-dimensions or three dimensions is acquired. The sequence of images SQ is displayed on the screen SCR.

It should be noted that acquisition of the sequence of images SQ is not necessary to the invention. In the embodiment of FIG. 1, the controller CTRL also controls this acquisition, however this acquisition may be controlled by a separate system. For instance, the acquisition may be performed by an acquisition system and the sequence of images sent, for instance by means of a wireless connection, to a system comprising means for controlling automatic detection of a feature of interest FI in the sequence of images SQ, computation of at least one parameter PA characteristic of said feature of interest FI for each image I of the sequence of images SQ, and automatic display of the parameter PAO having the greatest value among the computed parameters PA.

2) Automatic detection of a feature of interest FI.

The automatic detection may be based on a first step wherein an approximate shape recognition based on efficient implementations of matched filters (bright circle for the skull, disk for the abdomen, and line segment for the femur for example) is performed. This recognition step corresponds to a first detection of some candidate “features of interest” in the image. It is performed at low resolution, and doesn't aim at doing a fine segmentation.

For features of interest FI that have approximately a circular shape, such as a skull or an abdomen, such an approximate shape recognition may be performed with the Hough transform method well-known to a person skilled in the art. This Hough transform method is described for example in the document “R. O. Duda, and P. E. Hart, “Use of the Hough Transformation to Detect Lines and Curves in Pictures,” Comm.ACM, Vol. 15, pp. 11-15 (January, 1972)”.

This Hough transform first requires the parameterization of the sought feature of interest FI—e.g. for a circle it can be the radius and the center position—, and projecting some primitives that are extracted from the image—e.g. the edges—into a parameter space. One switches from a 2D space to the parameter space. Eventually the most salient peaks in the parameter space correspond to the best-matched sought feature in the image. It is robust against noise or missing features.

For features of interest FI which are approximately bright linear shapes, such as a femur, such an approximate shape recognition may be performed with a low-level threshold method well-known to a person skilled in the art. Such threshold methods are described for example in the document “J. S. Weszka and A. Rosenfeld, “Threshold evaluation techniques,” IEEE Trans. Syst. Man Cybern. SMC-8, 627-629 1978”. Threshold techniques separate objects from the background, based on their difference of gray levels. In this case it permits to identify a segment of curve which defines the feature of interest FI.

The second step of the automatic detection may perform a refining of the approximate segmentation—that may comprise several candidates—that results from the previous stage.

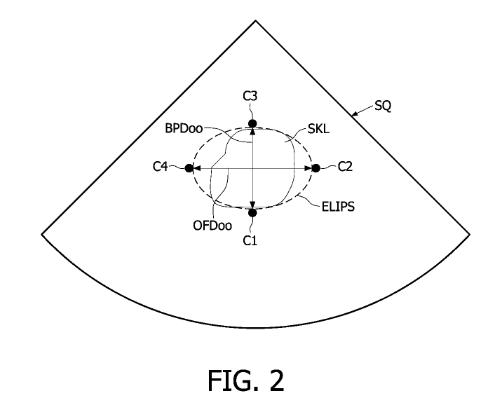

For features of interest FI which have approximately a circular shape, the refinement may be based on the “snakes” technique well-known by the person skilled in the art. Such a method is well described, for instance, in the document “Snakes: Active contour models,” M. Kass, A. Witkin, D. Terzopoulos, International Journal of Computer Vision, 1(4), 1987, 321-331. Man Prize Special Issue. It uses a parametric curve (that may be closed or open) via an energy minimization scheme. The curve parameters and the energy embed a priori knowledge of the size, shape, contrast that depicts the feature of interest. Then, an ellipse-fitting method well-known to a person skilled in the art is applied. Such a method is described, for instance, in the document “Direct Least Squares Fitting of Ellipses” from A. W. Fitzgibbon, M. Pilu, R.B. Fisher icpr p. 253, 13^{th} International Conference on Pattern Recognition (ICPR'96)—Volume 1,1996. From the curve found in the step before, an ellipse ELIPS that best fits the feature of interest FI according to a least squares error criterion is calculated. In FIG. 2, such an ellipse is shown for a skull SKL. In an embodiment, the ellipse ELIPS may be displayed automatically on the feature of interest FI detected as illustrated in FIG. 2.

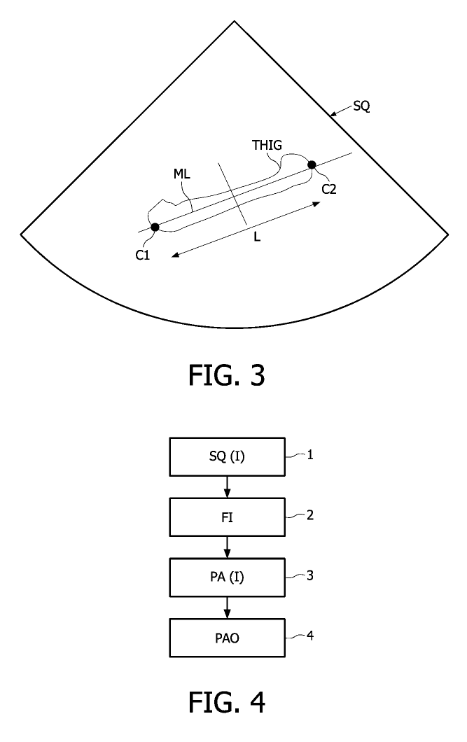

For features of interest FI which have approximately a linear shape, such as a femur, the second step may be based on an identification of a medial line ML of the feature of interest FI as illustrated in FIG. 3. This may be performed by a well-known method such as a skeletisation method, for instance following the technique described in “A. R. Dill, M. D. Levine, P. B. Noble, Multiple resolution skeletons, IEEE Transactions on Pattern Analysis and Machine Intelligence, v.9 n.4, p. 495-504, July 1987”.

Of course any method for automatically detecting a feature of interest in an image may be used.

It is to be noted that after the detection of the feature of interest FI, some calipers C may be automatically displayed on the detected feature of interest FI. They are set on the boundaries of said feature of interest FI.

In FIG. 2, one can see the placement of the calipers C on a skull SKL. Four calipers C1, C2, C3 and C4 are placed on the end points of the main axis of the ellipse that fits the skull SKL.

In FIG. 3, one can see the placement of the calipers on a femur THIG. Two calipers C1 and C2 are placed on both ends of the medial line ML of said femur THIG.
In an embodiment, the display of the calipers C is performed in real time for each image during the display of the sequence of images SQ. It permits the user to better locate the outline of the feature of interest FI during the display of the sequence of images SQ.
The user interface M USER may comprise means for the user to correct the position of the calipers C if he is not pleased with the automatic placement.

3) Computation of at least one parameter PA characteristic of said feature of interest FI for each image I of the sequence SQ.

For example, for a skull SKL, the computed parameter is the head size. It may be obtained from two other computed parameters, which are the outer-to-outer bi-parietal BPDoo and occipitofrontal OFDoo diameters as illustrated in FIG. 2.

In another example, for an abdomen, the computed parameter is the circumference.
In another example, for a femur THIG, the computed parameter is the length L as illustrated in FIG. 3. It is obtained from the two ends of the median line ML found during the second step (automatic detection).

In an embodiment, the computed parameter PA associated to an image is displayed on the screen SCR during the display of this image.

It is to be noted that the end of an acquisition may be performed by the user by freezing said acquisition in particular when he has captured an image he is interested in. The user interface M USER comprises means to permits such a freezing.

4) Automatic display of the computed parameter PAO which has the greatest value (e.g. the largest one) among the computed parameters PA. This computed parameter PAO may be displayed along with its corresponding image in SQ.

In an embodiment, this automatic display is performed at the end of the acquisition of the sequence SQ of images. It permits the user to obtain the parameter PAO that characterizes the best the feature of interest FI.

For example, for a thighbone THIG, the parameter PAO is the parameter PA between all the parameters of the images I acquired, which has the largest length.

For an abdomen, the parameter PAO is the parameter PA between all the parameters of the images I acquired, which has the largest circumference.

For a skull, the parameter PAO is the parameter PA between all the parameters of the images I acquired, which has the largest head size.

It is to be noted that in order to choose the greatest value PAO among the computed parameters PA and to optionally display the associated image I, the images I acquired during the acquisition of the sequence of images SQ may be saved in a memory MEM of the system SYS with their associated parameters PA computed as described before. The controller CTRL may retrieve the right parameter PAO from the set of parameters PA saved in the memory MEM.

FIG. 4 illustrates the method for medical imaging according to an embodiment of the invention where the different operations controlled by the system SYS are shown.

It should be noted that the above-mentioned embodiments illustrate rather than limit the invention, and that those skilled in the art will be capable of designing many alternative embodiments without departing from the scope of the invention as defined by the appended claims.

In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa.

The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A medical imaging system, comprising controlling means (CTRL) for controlling the following operations:
automatic detection of a feature of interest (FI) in a sequence of images (SQ) of a part of a body,
computation of at least one parameter (PA) characteristic of said feature of interest (FI) for each image (I) of the sequence of images (SQ), and
automatic display of the parameter (PAO) having the greatest value among the computed parameters (PA).

2. A system as claimed in claim 1, wherein the controlling means (CTRL) are also arranged to control the following operation: automatic display of the computed parameter (PA) associated to an image (I) during a display of said associated image (I).

3. A system as claimed in claim 1, wherein the computed parameter (PA) is a length of the feature of interest (FI)

4. A system as claimed in claim 1, wherein the controlling means (CTRL) are also arranged to control the following operation: automatic display of calipers (C), said calipers (C) being set on boundaries of the feature of interest (FI).

5. A method for medical imaging, comprising the steps of:
automatically detecting a feature of interest (FI) in a sequence of images (SQ) of a part of a body,
computing at least one parameter (PA) characteristic of said feature of interest (FI) for each image (I) of the sequence (SQ) of images, and
automatically displaying the parameter (PA) having the greatest value among the computed parameters (PA).

6. A computer program product comprising program instructions for implementing, when said program is executed by a processor, the method as claimed in the preceding claim.
